(19) United States
(12) Patent Application Publication
(10) Pub. No.: US 2004/0110556 A1
(43) Pub. Date: Jun. 10, 2004

(54) Tax supplement financial product for gaming and lottery participants

(76) Inventor: Stephen A. Bromfield, Fort Lauderdale, FL (US)

Correspondence Address: ROBERT C. KAIN, JR., 750 SOUTHEAST THIRD AVENUE, SUITE 100, FT LAUDERDALE, FL, 333161153

(21) Appl. No.: 10/464,323

(22) Filed: Jun. 18, 2003

Related U.S. Application Data
(63) Continuation-in-part of application No. 10/313,432, filed on Dec. 6, 2002.

(51) Int. Cl. A63F 13/00

(52) U.S. Cl. 463/25; 463/17

(57) ABSTRACT

A method and system for supplementing the taxes owed by gaming participant winners such that winners of games of chance, including lotteries, are able to collect more of the advertised jackpots. Included is a method for conducting a game of chance with a tax supplement component such that participants are permitted to purchase a game ticket with a tax supplement component. A first portion of the ticket price is allocated to a tax supplement pool representing a tax supplement for at least a portion of applicable taxes on respective prizes. A second portion of the ticket price is allocated to a prize pool. Winners who purchased the tax supplement ticket are provided a tax supplement payment. The method and system also provide for the purchase of a tax supplement option, making the purchasers of the option eligible to receive a tax supplement payment in the event they win the prize.

This is a continuation-in-part of co-pending U.S. patent application Ser. No. 10/313,432 filed Dec. 6, 2002.

This invention relates generally to gaming. More particularly, this invention relates to a method and system for increasing the revenues generated by gaming and lottery systems, thus enhancing the cash flow to the authorizing governmental agencies. As a corollary effect, the marketing may be also enhanced as may be consumer enjoyment of games of chance and lotteries. The present invention also relates to a tax supplement financial product for gaming and lottery participants, and more particularly the invention relates to a method, system, and software for increasing the revenues generated by gaming and lottery systems and for supplementing the taxes owed by winners of games of chance, including lotteries, such that winners are able to collect winnings closer in amount to the advertised jackpots.

### BACKGROUND OF THE INVENTION

Games of chance, whether sponsored by the state or by the private sector are becoming increasingly popular throughout the country. The success of electronic forms of gaming and the success of gaming via the Internet have provided venues and access to many persons wishing to participate in such games of chance who would not have otherwise had the opportunity. These games of chance vary greatly from simple wagering on sporting events, to lotteries, to bingo, to slot machines, and a whole host of other games. Although these games of chance vary greatly in form, they all share a common characteristic in that they all require the purchase of an entry to participate in the game. Participating in a lottery requires purchasing a lottery ticket; betting on a sporting event requires placing a wager (usually requiring a deposit or an actual purchase); playing bingo requires purchasing bingo cards, etc. One of the most popular games of chance is the lottery.

State-sponsored lotteries, and lotteries sponsored by groups of states, are well-known forms of gaming. A commonly used form of state-sponsored lottery requires consumers to purchase a lottery ticket from an authorized location by either choosing numbers, letters or other characters themselves or electing to have a random selection generated for them. The ticket displays the numbers selected by or for the consumer. Drawings are typically held once or twice a week. The funds generated by lotteries are typically divided between the amount allocated for paying winners and another government expenditure, commonly the sponsoring state's education budget. For an example of one state's allocation of funds generated by the lottery, see Florida Statutes § 24.121. The winner or winners may choose to receive the winnings either as an annuity over a number of years or in a lump sum payment.

However, regardless of which payment method the winner chooses, applicable federal, state, and local taxes may significantly reduce the amount actually realized as the winner will have the highest individual tax rate applied to the winnings, with their winnings reduced by the amount of tax owed. Many winners are surprised and severely disappointed when they do not realize the advertised amount of the winnings. Further, knowledge of the significant decrease in the amount the winner actually receives may discourage some potential consumers from participating in the lottery at all.

There are two reasons why the lottery winnings are not the actual advertised amount. One reason is that the amount that Lottery Commissioners advertise as the grand prize is actually the grand prize plus the imputed interest if it were disbursed out of an annuity. Thus, the prize grows two or three-fold, or more. The second reason is that applicable taxes will be levied upon the income represented by the prize money. This is not considered in the statement of the grand prize pool.

The foregoing lottery example applies to other games of chance as well. The winner is responsible for paying applicable taxes on winnings, often times significantly decreasing the amount received by the winner. By making gaming generally, and specifically lotteries, more attractive to consumers who currently participate and to potential consumers, the entities sponsoring the gaming or lotteries may realize greater revenues.

Various attempts have been made to increase convenience and revenues generated by gaming. One such attempt can be found in the invention disclosed in U.S. Pat. No. 6,312,333 B1, issued to Acres. This invention comprises a method for monitoring winnings, or bonuses, won at electronic gaming machines via a computer network, and stopping play when the consumer wins a bonus that exceeds a predetermined amount to allow for compliance with federal income tax laws. When a bonus exceeds the set amount, the proper IRS forms are automatically generated by a computer, based on the identification information the consumer previously supplied, and the proper tax amount is automatically deducted from the bonus. The invention contemplated in this patent does not include reimbursing the winner for taxes withheld from the grand prize. Instead, it merely changes the process of complying with tax laws from a slower, paper transaction to a faster, automated transaction.

Another example can be found in U.S. Pat. No. 5,505,461, issued to Bell, et al., which discloses a method similar to that disclosed in Acres. The Bell patent adds the function of retaining on a computer network a tally of the consumer's bonuses that exceed a predetermined amount. When the consumer is finished playing, the proper tax forms are completed either manually by a casino employee or automatically printed by the computer network. This invention does not contemplate reimbursing the winner for taxes withheld from the grand prize. Instead, it changes the process of deducting the tax from many manual paper transactions, each interrupting game play, to one computer-driven transaction completed when the consumer is finished gaming.

A further attempt can be found in U.S. Pat. No. 6,322,446 B1, issued to Yacenda, which discloses a system and method for allowing consumers to purchase lottery tickets and play lottery games via the Internet. This invention contemplates verifying the identity of the consumer to ensure he or she is eligible to play lottery games, granting the consumer access to the games, requiring the consumer to report to a state agency if the winnings are higher than a predetermined amount in order to receive the winnings, and crediting the consumer's selected account if the winnings are less than the set amount. Regardless of how the consumer receives the winnings, the applicable federal, state, and local taxes are still deducted from the amount won and the winner is not reimbursed for the amount of taxes withheld.

Accordingly, the need remains to allow winners of games of chance to realize all or at least more of the advertised amount of the jackpot while fully complying with applicable federal, state, and local tax laws.

### OBJECTS OF THE INVENTION

It is an object of the present invention to increase the realized amount of winnings of prize winners interested in participating in a game of chance by offering the purchase of an entry into such game which includes a supplemental tax component.

It is a further object of the present invention to improve the net revenues generated by games of chance to all operators of such games by generating further interest in consumers viz-a-viz a tax supplement offered to offset or pay at least part of the taxes owed by winners of the game.

It is a further object of this invention to enhance the marketability of all games of chance, whether privately operated or operated by federal, state, regional, or local governments, or by private industry, by eliminating an obstacle that deters some consumers from participating, namely the significant reduction in the amount actually realized by the winner.

It is an object of the present invention to increase the realized amount of winnings of grand prize winners interested in participating in an expanded version of the lottery.

It is a further object of the present invention to improve the net revenues generated by lotteries to all operators of lotteries.

It is yet a further object of this invention to enhance the marketability of any lotteries, federal, regional, state-sponsored, or local in nature, by eliminating a deterrence that keeps some consumers from participating, namely the significant reduction in the amount actually realized by the winner.

### SUMMARY OF THE INVENTION

The present invention relates to a method and system for increasing the revenues generated by gaming and lottery systems, thus enhancing the cash flow to the authorizing governmental agencies, and for supplementing the taxes owed by gaming participant winners such that winners are able to collect winnings closer in amount to the advertised jackpots. The present invention includes a method for conducting a lottery game with a tax supplement component such that lottery participants are offered and permitted to purchase a lottery ticket with a tax supplement component having an associated ticket price. A first portion of the ticket price of a purchased tax supplement lottery ticket is allocated to a tax supplement pool, at least a portion of which represents a tax supplement for lottery participant winners for at least a portion of applicable taxes on respective lottery prizes. A second portion of the ticket price is allocated to a lottery prize pool, at least a portion of which represents respective lottery prizes for the lottery participant winners. Lottery participant winners are identified and awarded respective lottery prizes from the lottery prize pool. Lottery participant winners who purchased the tax supplement lottery ticket are provided a tax supplement payment. The method may also include offering and permitting the purchase of a second lottery ticket with no tax supplement component, and then allowing such purchasers the opportunity to purchase a lottery supplement option before the lottery, make them eligible to receive a tax supplement payment in the event they win the lottery. The tax supplement payment is calculated based upon the tax supplement pool and the respective lottery prizes.

The present invention also includes a method for conducting a lottery game with a tax supplement component wherein game participants are offered and permitted to purchase a lottery tax supplement option, separately from, or in combination with, a lottery ticket. The price of the tax supplement option is allocated to the tax supplement pool to provide a tax supplement payment to any lottery winners who purchased the option.

Additionally, the present invention includes a computerized method for conducting a lottery game with a tax supplement component. The computerized method offers and permits the purchase of a lottery ticket with a tax supplement component by lottery game participants. The computerized method then electronically allocates a first representative portion of the ticket price of a purchased tax supplement lottery ticket to a tax supplement pool, at least a portion of which represents a tax supplement for lottery participant winners for at least a portion of applicable taxes on respective lottery prizes. The computerized method also electronically allocates a second representative portion of the ticket price of the purchased tax supplement lottery ticket to a lottery prize pool, at least a portion of which represents respective lottery prizes for all lottery participant winners. Next, the computerized method electronically identifies and generates awards for the lottery participant winners from the lottery prize pool and provides a provision for a tax supplement payment for the lottery participant winners who purchased the tax supplement lottery ticket. The computerized method may also include offering the lottery participants an opportunity to purchase a regular lottery ticket with no tax supplement component, and then purchase a tax supplement option later.

Another computerized method of conducting a lottery game with a tax supplement component is also included. This alternative computerized method operates via a primary lottery computer system coupled to at least one lottery computer terminal. The method offers and permits the purchase of a lottery ticket with and without a tax supplement component via at least one lottery computer terminal, the lottery tickets having respective first and second ticket prices. At the primary lottery computer system, the method includes allocating a first representative portion of the first ticket price of a purchased tax supplement lottery ticket to a tax supplement pool, at least a portion of which represents a tax supplement for lottery participant winners who purchased the tax supplement lottery ticket. The method also allocates a second representative portion of the first and second ticket prices to a lottery prize pool, at least a portion of which represents respective lottery prizes for all lottery participant winners. After identifying lottery winning tickets and prizes, if any, the method generates a tax supplement schedule based upon the tax supplement pool and prizes.

The present invention includes conducting the computerized method described above via a web-based system wherein the primary lottery computer system includes at least one server computer, and the method includes coupling that server computer to at least one lottery computer terminal via a telecommunications network such as the Internet.

The present invention also provides a computer readable medium containing programming instructions for conducting a lottery game with a tax supplement component from a primary lottery computer system coupled to at least one lottery computer terminal. The computer readable medium programming instructions offer and permit the purchase of a lottery ticket with a tax supplement component via at least one lottery computer terminal. The lottery ticket has an associated ticket price. The instructions associate a first representative portion of the ticket price of a purchased tax supplement lottery ticket to a tax supplement pool, at least a portion of which represents a tax supplement for lottery participant winners who purchased the tax supplement lottery ticket. The instructions also associate a second representative portion of the ticket price to a lottery prize pool, at least a portion of which represents respective lottery prizes for all lottery participant winners. Next, the instructions identify lottery winning tickets and prizes, if any, and generate a tax supplement schedule based upon the tax supplement pool and prizes.

The present invention includes an information processing system for conducting a lottery game with a tax supplement component. The information processing system includes at least one primary lottery computer system coupled to at least one lottery computer terminal. The system includes at least one lottery computer terminal permitting the purchase of a lottery ticket with a tax supplement component. The lottery ticket with the tax supplement component has an associated ticket price. The system includes means for allocating a first representative portion of the ticket price of a purchased tax supplement lottery ticket to a tax supplement pool, at least a portion of which represents a tax supplement for lottery participant winners who purchased the tax supplement lottery ticket. The system also includes means for allocating a second representative portion of the ticket price to a lottery prize pool, at least a portion of which represents respective lottery prizes for all lottery participant winners. The system also includes another computer system for identifying lottery winning tickets and prizes, and for generating a tax supplement schedule based upon the tax supplement pool and prizes.

The present invention also provides a method of communicating information for conducting a lottery game with a tax supplement component between a primary lottery computer system and at least one lottery computer terminal of a plurality of lottery computer terminals. The lottery game includes offering and permitting the purchase of a lottery ticket with and without a tax supplement component via at least one lottery computer terminal. The lottery tickets have first and second ticket prices, respectively. The primary lottery computer system allocates a first representative portion of the first ticket price of a purchased tax supplement lottery ticket to a tax supplement pool, at least a portion of which represents a tax supplement for lottery participant winners who purchased the tax supplement lottery ticket. The primary lottery computer system also allocates a second representative portion of the first and second ticket prices to a lottery prize pool, at least a portion of which represents respective lottery prizes for all lottery participant winners. The computer system also identifies lottery winning tickets and prizes, if any; and generates a tax supplement schedule based upon the tax supplement pool and prizes. According to the present invention, the method of communicating the information includes transmitting a data packet representing the aforementioned purchase of the lottery ticket with the tax supplement component from at least one lottery computer terminal to the primary lottery computer system; and gathering all the representative data packets from the plurality of lottery computer terminals prior to identifying lottery winning tickets and prizes.

The present invention includes a method of conducting a lottery game with a tax supplement component deployed in a server-client computer system with at least one server computer operatively coupled to at least one client computer over a communications network. The client computer accepts data input which includes lottery ticket data, and the at least one server computer allocates a representative portion of the lottery ticket price for any purchased lottery tickets to a lottery prize pool, at least a portion of which represents lottery prizes for lottery participant winners. The at least one server also identifies any lottery winning tickets. The method includes (i) serving a lottery ticket offer for a ticket price which includes a tax supplement component via the at least one server computer to at least one client computer; (ii) confirming payment of the ticket price; (iii) accepting lottery ticket selections as adapted to be uploaded from the at least one client computer; (iv) allocating a first portion of the ticket price to a tax pool, at least a portion of which represents a tax supplement for lottery participant winners for at least a portion of applicable taxes on respective lottery prizes; and (v) generating a tax supplement schedule based upon the tax supplement pool and the prizes.

The present invention also provides for a method of conducting a lottery game with a tax supplement component deployed in a server-client computer system with at least one server computer operatively coupled to at least one client computer over a communications network, such as, for example, the Internet. The client computer accepts data input which includes lottery ticket data. The method includes (i) serving a lottery ticket offer with a tax supplement component, the lottery ticket offer including a purchase price, and the serving accomplished via a lottery server computer to at least one client computer; (ii) accepting at the lottery server computer lottery selections based upon the lottery ticket offer upon confirmation of payment of the purchase price and as adapted to be uploaded from the at least one client computer; (iii) allocating a first portion of the purchase price to a tax pool at the lottery server computer, at least a portion of which will be used to reimburse any winners of the next lottery for at least a portion of applicable federal, state, and local taxes on any respective lottery prizes; (iv) allocating a second portion of the purchase price to a lottery award pool at the lottery server computer, at least a portion of which represents the respective lottery prizes from which any winners are paid; (v) identifying lottery winners who purchased the lottery ticket including a tax supplement component such that any such winners may be reimbursed for at least a portion of the taxes from the tax pool.

The present invention also provides a method for conducting a game of chance with a tax supplement component. The method includes (i) offering and permitting the purchase of a wager with a tax supplement component by game participants—the wager having a price; (ii) allocating a first portion of the price of a purchased tax supplement wager to a tax supplement pool, at least a portion of which represents a tax supplement for game participant winners for at least a portion of applicable taxes on respective game prizes; (iii) allocating a second portion of the price to a game prize pool, at least a portion of which represents respective game prizes for the game participant winners; (iv) identifying and awarding the game participant winners from the game prize pool and providing a tax supplement payment for game participant winners who purchased the tax supplement wager.

The present invention provides for a method for conducting an electronic game of chance with a tax supplement component. The method includes (i) offering and permitting the purchase of a tax supplement wager option to game participants, the tax supplement wager option having an associated price; (ii) allocating at least a portion of the associated price of a purchased tax supplement wager option to a tax supplement pool, at least a portion of which represents a tax supplement for game participant winners; and (iii) identifying and making a provision for a tax supplement payment for the game participant winners who purchased the tax supplement wager option for at least a portion of applicable taxes on respective game prizes awarded to the game participant winners.

The invention is also directed to a system and method for maintaining a state-sponsored lottery or lottery sponsored by any legally authorized entity, in which consumers purchase a lottery ticket at a price that is nominally higher than standard prices and at least a portion of the excess amount is used to pay premiums on an insurance policy or to otherwise fund a pool that will reimburse any winner or winners for the taxes that were withheld. A portion of the excess may be new revenue for the sponsoring entity.

In one embodiment of the invention, the state sponsoring the lottery or its agents will charge consumers an additional, nominal amount, for example but not by way of limitation, an additional twenty-five to fifty cents per lottery ticket, which typically cost one dollar. At least a portion of the additional funds are used to purchase an insurance policy or to otherwise fund a pool, referred to herein as a tax pool, that will pay a reimbursement amount to the winner or winners for at least a portion of the taxes withheld. A portion of the excess may be new revenue for the sponsoring entity. Since many states currently contract with insurance companies to pay the annuity option chosen by some lottery winners, determining the terms of this insurance policy will not be burdensome on the sponsoring states. The reimbursement amount will be imputed as income to the winner, and the winner will have to pay taxes on that amount, a figure significantly lower than the taxes on the entire winnings.

It is also contemplated that the tax pool could be structured to reimburse the winner or winners for the tax on the reimbursement amount. That amount will also be imputed as income to the winner or winners. The tax pool could then reimburse the winner or winners for the amount of taxes on the second reimbursement. This reimbursement cycle can, but does not necessarily, continue reiteratively until the amount of income taxed is mere pennies. The invention contemplates payment of a reimbursement amount for the tax on prizes, and also a reiterative reimbursement that continues for as long as is specified by the sponsoring entity. A representative example is shown in the table below:

| | Estimated Tax | | Reiterative Tax |
|---|---|---|---|
| Grand Prize | Rate | Tax on Grand Prize | on Reimbursement |
| $1,000,000 | 0.3 | $300,000.00 | $90,000.00 |
| | | | $27,000.00 |
| | | | $8,100.00 |
| | | | $2,430.00 |
| | | | $729.00 |
| | | | $218.70 |
| | | | $65.61 |
| | | | $19.68 |
| | | | $5.90 |
| | | | $1.77 |
| | | | $0.53 |
| | | | $0.16 |
| | | | $0.05 |
| | | | $0.01 |

In an alternative embodiment, consumers can elect whether they wish to purchase a standard lottery ticket or the somewhat more expensive ticket referenced above. Those winners who chose the standard lottery ticket will have the applicable federal, state, and local taxes withheld as is currently done. The winners who purchase the more expensive ticket will also have the applicable federal, state, and local taxes withheld, but will be reimbursed from the tax pool for at least some portion of the taxes withheld. The amount of the reimbursement will be considered imputed income. It is possible that there could be multiple winners from one drawing, some of whom purchased the standard ticket and some of whom purchased the tax-reimbursement option. In this situation, those who purchased the standard ticket will have the applicable federal, state, and local taxes withheld from the winnings. Those who purchased the more expensive ticket will also have the applicable taxes withheld, but will be reimbursed for at least some portion of the amount withheld.

### BRIEF DESCRIPTION OF THE DRAWINGS

Further objects and advantages of the present invention can be found in the detailed description of the preferred embodiments when taken in conjunction with the accompanying drawings in which:

FIG. 1A is a block diagram generally explaining the gaming system and method of providing a tax supplement for game winnings of the present invention;

FIG. 1B is a block diagram of a first embodiment of the invention;

FIG. 2 is a flow diagram of the first embodiment of the invention;

FIG. 3. is a flow diagram of an alternate embodiment of the invention;

FIG. 4 is a schematic diagram of a networked gaming computer system; and

FIG. 5 is a flow diagram of a tax supplement program.

### DETAILED DESCRIPTION OF THE PREFERRED AND OTHER EMBODIMENTS

The present invention relates to a method, system, and software for increasing the revenues generated gaming systems, including lottery systems, and for supplementing the taxes owed by gaming system winners such that winners are able to collect winnings closer in amount to the advertised jackpots.

It is important to note that the embodiments of the invention described below are only examples of the several advantageous uses of the innovative teachings described herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

In the drawings, like numerals refer to like parts through the several views.

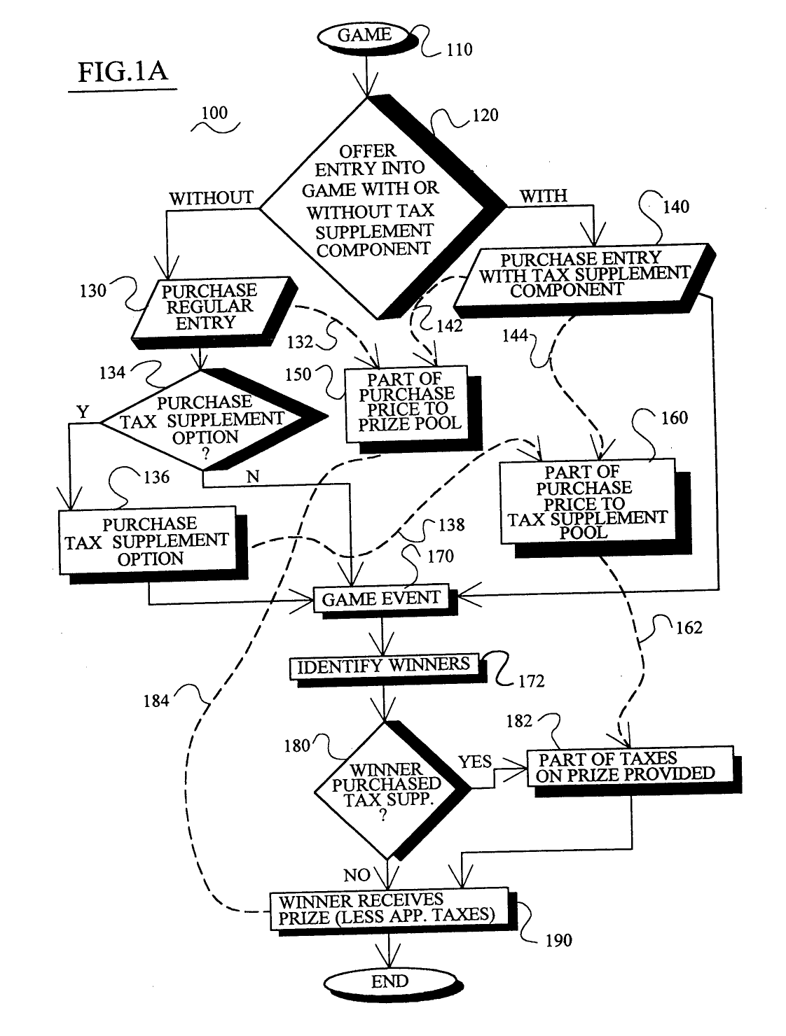

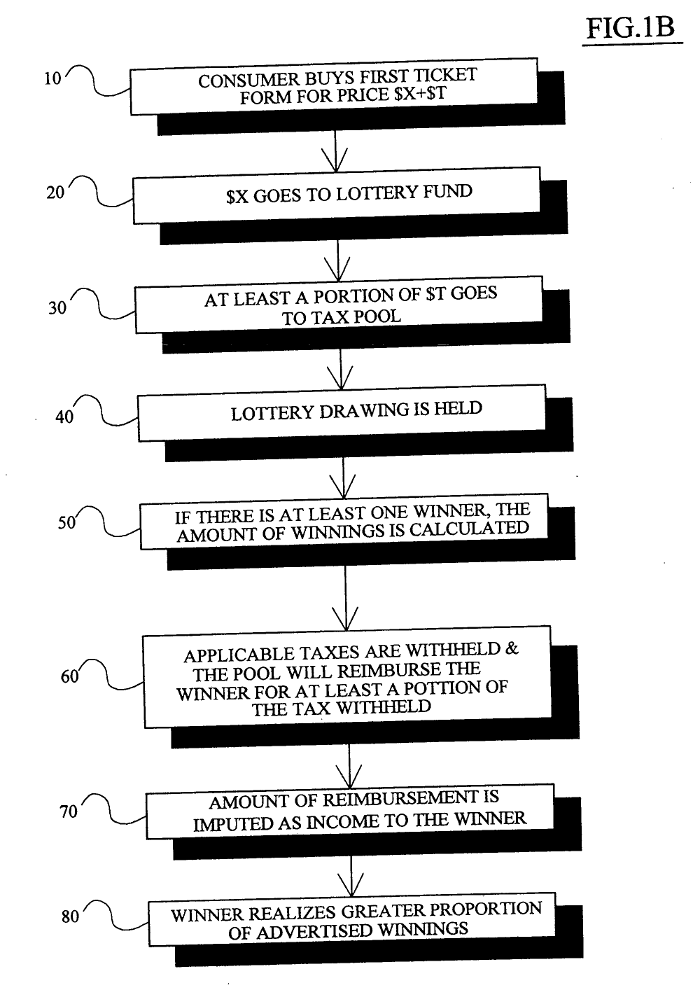

The gaming system and method of providing a tax supplement for game winnings of the present invention is generally described in the block diagram of FIG. 1A. The method of conducting a game of chance with a tax supplement component is referred to generally as 100. The game of chance begins at block 110. A game participant is offered the opportunity to purchase an entry into the game at 120. The game entry can take many forms. For example, for a lottery, the offer to purchase an entry may involve the offer to purchase a paper lottery ticket, or may be an electronic display which offers the viewer a menu of choices from which to select via touch screen, keyboard, mouse, voice recognition or other hardware/software interactive systems as is known to those skilled in the art. After the game participant selects the proper entry or form, he or she proceeds to a respective purchase block 130, 140. At this point, the game participant purchases his/her entry into the game.

At block 130, the participant purchases a normal game entry, i.e. a regular entry as is known in the prior art. For example, with respect to a lottery, a participant may present a lottery form with selections, or may request that a random selection be made. The participant would then present the purchase price, whether through cash or otherwise. In a computer-based model, an example of this point in the process would be permitting the participant to input data into an electronically presented lottery ticket form and request a payment method. For example, if a lottery is operated via the Internet, the lottery computer system may serve an offer page to a game participant's computer via a telecommunications network. The offer is then presented to the display monitor and would allow the game participant to make selections which are then returned to the lottery computer. Once a purchase has been made, at least part of the purchase price is allocated (dashed arrow 132) to prize pool 150. Prize pool 150 is representative of the size of the prize(s) available to game participant winners.

At block 140, the participant purchases a game entry which includes an additional feature—a tax supplement component. In one embodiment, the game participant is notified that the game entry with the tax supplement component includes a surcharge or additional price component. In another embodiment, the participant simply purchases the game entry having a total price that includes the additional price for the tax supplement component. For example, if a normal lottery ticket costs $1, a lottery ticket with a tax supplement component may cost an additional $0.25 for a total price of $1.25. Similar to block 130, at least a portion of the purchase price of the tax supplement entry at block 140 is allocated (dashed arrow 142) to the prize pool 150. Other portions of the purchase price for the game entry may represent administrative costs in conducting the game or revenues to fund unrelated activities. At least a portion of the additional cost for the game entry with the tax supplement component is allocated (dashed arrow 144) to a tax supplement pool 160 used to offset at least a portion of the taxes owed by game participant winners who purchased the game entry with the tax supplement component. Again, other portions of the tax supplement component price maybe utilized to cover administrative costs or to generate further revenues for the sponsoring entity.

The game participants who purchased a regular game entry at block 130 have an opportunity to purchase a tax supplement option at decision block 134. The tax supplement option simply represents an offer to a game participant to participate in the tax supplement pool by purchasing a tax supplement option prior to the gaming event. If the participant opts not to purchase such an option, then he or she proceeds to the game event at block 170. If the participant does purchase a tax supplement option at block 136, then at least a portion of the tax supplement option price is allocated (dashed arrow 138) to the tax supplement pool 160, and the participant proceeds to game event block 170. The game event may be a lottery drawing, a bingo game, the sporting event for which the participant placed a bet or made a wager, or any number of games of chance. The tax supplement option is available to a game participant at any time prior to the game event taking place. Hence, the tax supplement option may be exercised at the same time as the purchase of a game entry or subsequent to the purchase of the game entry.

The gaming event 170 determines whether there will be any winners. In the case of a lottery, it is possible that none of the game participants selected the winning lottery numbers, letters or other lottery characters. In such a case, it is customary to have the lottery prize pool and, in this instance, the tax supplement pool, roll over until the next lottery game event. Although this is not mandatory, it is preferred because increasing the size of the prize pool and supplemental tax pool provides additional incentives for further participation in the gaming event. If anyone was successful with respect to the game event, then those persons present their winning entry at block 172. The presented winning entries are verified at block 172.

The game system 100 then determines whether the presented winning entry included the tax supplement component at decision block 180. If yes, then the winning game participant is entitled to at least a partial payment, reimbursement, offset or the like for taxes owing for the prize at block 182 (see dashed arrow 162). The winning game participant also receives the game prize less applicable taxes at block 190 (see dashed arrow 184). The order in which the winning game participants who purchased a game entry with a tax supplement component receive a credit for the taxes owing on the prize or the actual prize is not important. Such winners may receive the prize, less applicable taxes, and then receive a payment for at least part of the applicable taxes. The gaming sponsor could send a tax payment directly to the taxing authority and give the winner a prize award closer in amount to the advertised prize. The aforementioned winners include both (i) those who purchased a winning entry that included the tax supplement component (block 140), and (ii) those that decided to purchase a tax supplement option prior to the game event at block 136.

The winning game participants who did not purchase an entry with a tax supplement component or a tax supplement option simply receive the prize, less applicable taxes, at block 190, as is customary in the prior art.

The supplemental tax pool 160 maybe a simple accounting tool utilized to determine the amount of payment, reimbursement, offset or the like that will be made available to game participant winners who purchased a game entry which included the tax supplement component or who purchased a tax supplement option. The actual funds allocated to the tax supplement pool may be invested in any number of financial vehicles, or a combination of financial vehicles, that will receive the funds generated from at least a portion of the $T portion of the ticket price. For example, but not by way of limitation, the tax pool could be an escrow account, an insurance policy, an annuity, or an interest-bearing account. All financial arrangements that will fulfill the object of receiving the funds and having them available for withdrawal to pay a winner's tax liability on his or her portion of the grand prize are contemplated by this invention.

### Lottery System

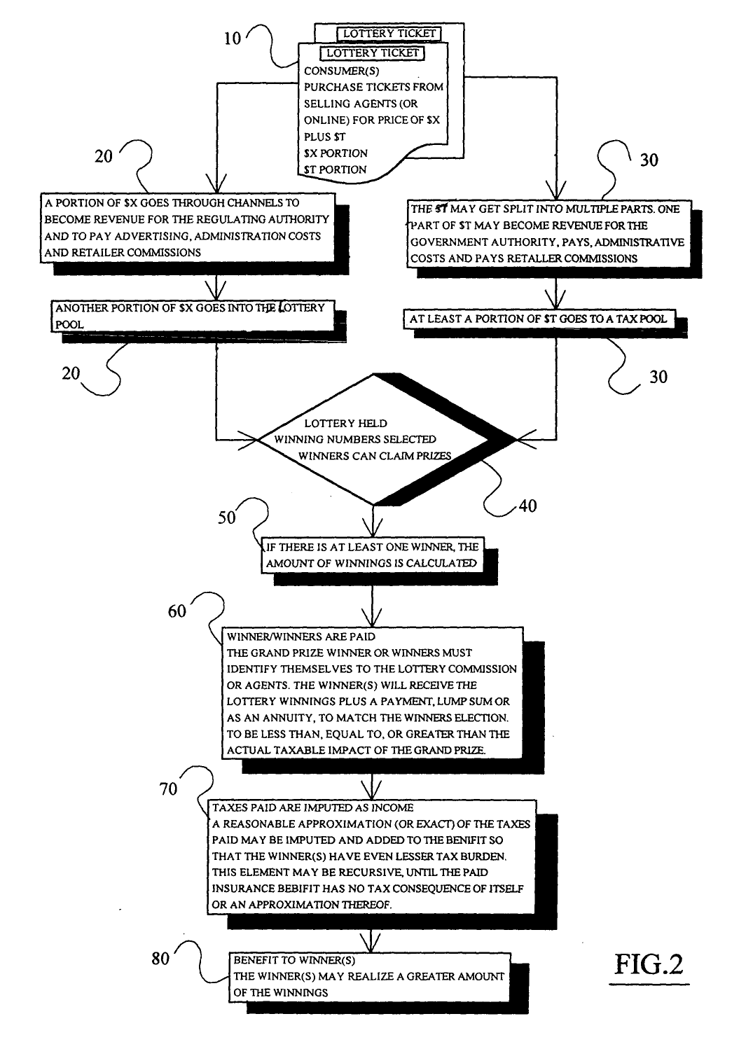

Referring now to the drawings, a first embodiment of a lottery system with a supplemental tax component is illustrated in FIGS. 1B and 2. A consumer purchases a first ticket form at step 10 for a price of $X+$T. A first portion of the ticket price, $X, goes to a general lottery fund at step 20. At step 30, a second portion of the ticket price, $T, goes to a tax pool, at least a portion of which is used to reimburse any winner(s) for at least some of the federal, state, and local taxes withheld from the grand prize. Another portion of the tax pool may be new revenue for the sponsoring entity. It is understood that any chronological sequence of depositing the portions of the ticket price is contemplated by this invention. A lottery drawing is held at step 40. If there is at least one winner, the amount of each winner's portion of the grand prize is calculated at step 50, taking into consideration the number of winners, whether the winner chose to receive an annuity or lump sum payment, and other relevant factors as known to one skilled in the art. The applicable federal, state, and local taxes arising out of each winner's portion of the grand prize are withheld and each winner is reimbursed for at least some of the taxes withheld from the funds in the tax pool at step 60. The amount of reimbursement is imputed as income to the winner at step 70 and the winner will be responsible for federal, state, and local taxes on this amount. If the sponsoring entity chooses to reimburse the winner(s) for the tax on the initial reimbursement in the reiterative manner previously addressed, this computation and payment is also performed at step 70. Since this amount of tax is significantly lower than the taxes on the winner's portion of the grand prize, the winner realizes a greater amount of the advertised prize at step 80.

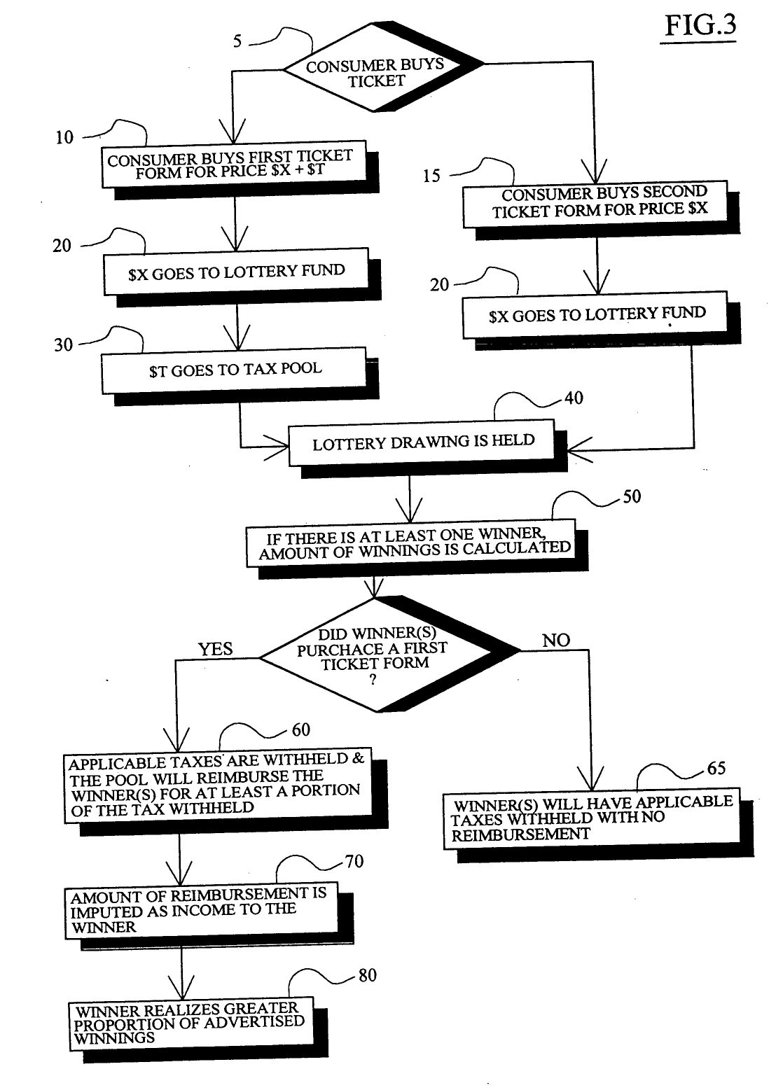

In an alternate embodiment as shown in FIG. 3, the consumer or lottery participant makes a decision at step 5 of whether to purchase a first ticket entry form or a second ticket entry form. If the consumer purchases the first ticket form at step 10 for a price of $X+$T, $X goes to a lottery fund at step 20. At step 30, a second portion of the ticket price, $T, goes to the tax pool, at least a portion of which is used to reimburse any winner(s) for at least some of the federal, state, and local taxes withheld from the grand prize. If the consumer purchases a second ticket form at step 15 for a price of $X, the entire ticket price goes to a lottery fund at step 20. Both the first ticket form and the second ticket form correspond to the same lottery drawing, which occurs at step 40. If there is at least one winner, the amount of each winner's portion of the grand prize is calculated at step 50, taking into consideration the number of winners, whether the winner chose to receive an annuity or lump sum payment, and other relevant factors as known to one skilled in the art. Any winner who purchased a second ticket form will have the applicable federal, state, and local taxes withheld from his or her portion of the grand prize at step 65. At step 60, any winner who purchased a first ticket form will also have the applicable federal, state, and local taxes withheld from his or her portion of the grand prize, but will receive a reimbursement from the tax pool of at least a portion of the taxes withheld. The amount of taxes paid is imputed as income to the winner who purchased the first ticket form at step 70 and the winner will be responsible for the applicable federal, state, and local taxes on this amount. If the sponsoring entity chooses to reimburse the winner(s) for the tax on the initial reimbursement in the reiterative manner previously addressed, this computation and payment is also performed at step 70. Since this amount of tax is significantly lower than the taxes on the full amount of the grand prize, the winner realizes a greater amount of the advertised winnings at step 80.

Statistically, given a choice, consumers will be more likely to purchase the first ticket form with the additional cost of $T when $T is a small number. For example, but not by way of limitation, consider the situation where the second ticket entry form sells for $1 as standard lottery tickets currently do. If $T is $1 and the first ticket form sells for $2, consumers will be less likely to purchase the first ticket form than if $T is $0.25, bringing the total cost of the first ticket form to $1.25. Thus, to maximize the desirability of the first ticket form, the price of $T should be kept as low as possible while maintaining a sufficient balance in the tax pool to cover the reimbursement of the winners' tax liability. Those skilled in the art will appreciate that there are a variety of statistical and/or actuarial methods which maybe employed to arrive at the optimal price for the first ticket entry form.

This invention also contemplates a method for conducting a lottery comprising offering a first ticket form for sale for a first ticket price, which can be expressed as $X+$T, at step 10. The next step 20 is allocating the portion of the first ticket price labeled $X to the lottery fund, which is divided by sponsoring entities between a prize pool and other budget needs, for example but not by way of limitation, education costs for states. Next, at step 30, allocate at least some of the portion of the first ticket price labeled $T to a tax pool, a portion of which is used to reimburse any winner(s) for at least some of the federal, state, and local taxes withheld from the grand prize. Hold a lottery drawing at step 40. If there is at least one winner, calculate the amount of each winner's portion of the grand prize at step 50, taking into consideration the number of winners, whether the winner chose to receive an annuity or lump sum payment, and other relevant factors as known to one skilled in the art. Reimburse the winner(s) for at least a portion of the applicable federal, state, and local taxes withheld from each winner's portion of the grand prize from the tax pool at step 60. At step 70, impute as income to the winner(s) the amount of tax paid. Pay the winner or winners from the prize pool. If the sponsoring entity chooses to reimburse the winner(s) for the tax on the initial reimbursement in the reiterative manner previously addressed, compute and pay this amount at step 70. Since the winner or winners will only have to pay tax on the amount of taxes paid on their behalf, they realize a greater proportion of the advertised winnings at step 80.

The tax supplement financial product for gaming and the method of conducting a game of chance having a tax supplement component of the present invention 100 may be implemented and used in numerous configurations.

### Exemplary Network

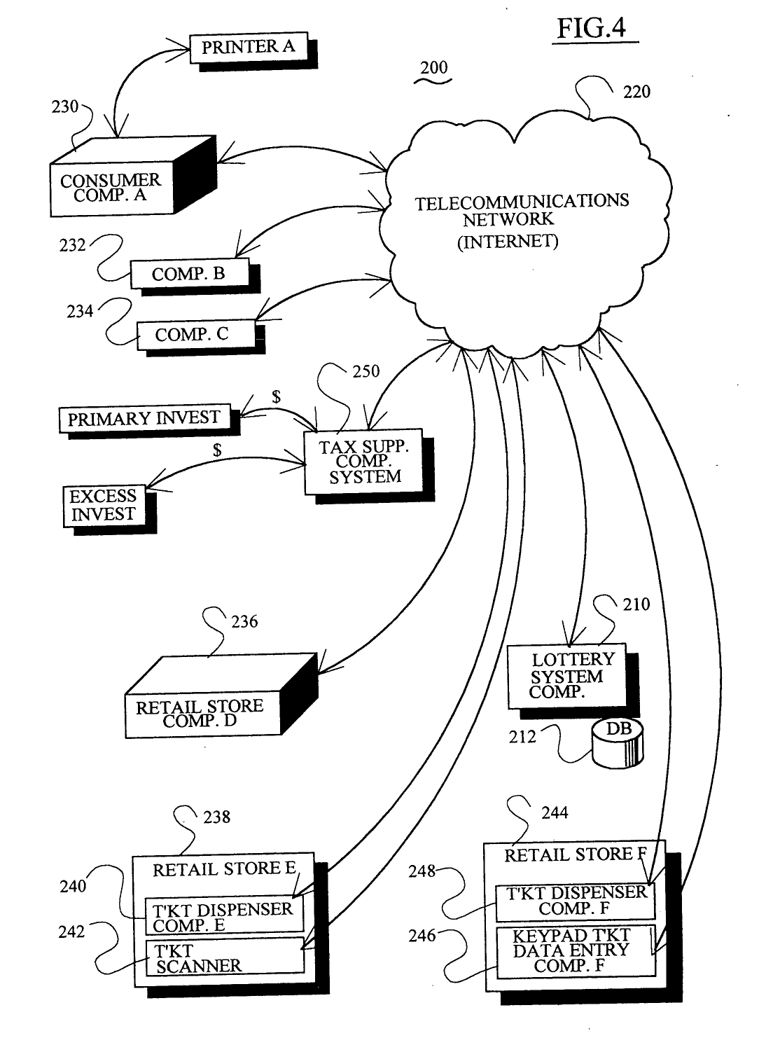

FIG. 4 diagrammatically illustrates a schematic of a computer system 200 used in connection with an embodiment of the present invention. The following abbreviations are used in the drawings and below to describe certain aspects of the present invention:

| | |
|---|---|
| Pgm | program |
| Supp | supplement |
| Tkt | ticket |
| e-Tkt | electronic ticket |
| est | estimated |
| calc | calculate |
| Y | yes |
| N | no |
| Comp | computer |
| DB | database |

Retail Store any public or private facility that sells entries to games of chance

In FIG. 4, certain components have been labeled or identified with respect to a lottery computer system. However, reference to a lottery is merely exemplary and should not be considered as a limitation. The system 200 illustrated in FIG. 4 may also be implemented to conduct other games of chance with a tax supplement component.

The lottery system computer 210 is coupled via the telecommunications network 220 (e.g., the Internet) to various consumer or game participant computers 230, 232, 234. The lottery system computer is illustrated adjacent database 212. Database 212 may be used to store information related to game entries, such as lottery selections, number of tickets sold, and location of sales. It may also be used to allocate a representative portion of a lottery ticket purchase to the prize pool and to a tax supplement pool.

In FIG. 4, consumer comp A (computer A), comp B and comp C represent a plurality of lottery computer terminals providing access to lottery game participants. Computers A, B and C may be home computers or individual-owned computers with Internet access. They may also represent a free-standing, lottery computer terminal 230, available, for example, in a hotel lobby or in a shopping mall. The configuration and location of the lottery computer terminals 230, 232, 234 also depends upon its intended use. Retail stores E and F (238 and 244, respectively) diagrammatically illustrate two exemplary configurations.

Retail store E illustrates a lottery computer terminal in which a lottery ticket form is inserted into a ticket scanner 242 such as an optical scanner. The game participant or a retail store clerk may enter the lottery ticket form or entry into the scanner 242 for purchase. Once the lottery selections have been accepted by the scanner 242, a ticket dispenser 240 coupled to the lottery computer terminal provides a paper lottery ticket. Of course, as is known in the prior art, the lottery ticket form may also include a selection for generating a random selection of numbers, letters or other characters.

Retail Store F illustrates a lottery computer terminal F having a keypad ticket data entry 246. Again, the game participant or the retail store clerk may enter the selections or request that a random selection by made by the computer via keypad 246. Upon a selection being made, ticket dispenser 248 prints a paper lottery ticket. Alternatively, the gaming computer terminal could present the ticket entry via an electronic display and offer the game participant the ability to print a ticket for his or her records. The term “ticket” as used herein is intended to encompass an electronic ticket or e-tkt as well. Such e-tickets could be presented via an electronic display.

Tax supplement computer system 250 is also coupled to the lottery computer system 210 and the consumer lottery computer terminals 230, 232, 234, 236, 238 and 244 via the telecommunications network 220. The tax supplement computer 250 may also be part of the lottery computer 210, i.e., the same hardware may contain both the gaming program and the tax supplement program. Conversely, the tax supplement system 250 maybe a completely independent system from that of the game for which it operates. If the tax supplement system 250 is independently run, the only requirement is that the tax supplement system have the ability to confirm or verify the authenticity of game entries presented for purposes of buying a tax supplement option. Verification may be conducted by accessing the game system database 212. The illustrated scheme in FIG. 4 is one of many possible configurations.

The method for conducting a lottery game with a tax supplement component operates as follows. The game participants access the game via lottery computer terminals 230, 232, 234, 236, 238 and 244. These terminals may be located in a person's home, in a retail store, a convenience store, or any other location. The lottery computer terminals offer and permit the purchase of a lottery ticket with a tax supplement component by lottery game participants. The terminals may also offer and permit the purchase of a regular lottery ticket. Each type of lottery ticket has an associated price. Typically, the price for a lottery ticket having the tax supplement component will be slightly higher than the no-tax supplement lottery ticket. The game participant then makes a selection at the terminal. Again, the selection may be simply requesting that the computer randomly generate a lottery ticket selection. The game terminal then prompts the game participant for method of payment. This aspect of the transaction may be accomplished via a plethora of methodologies as is known to those skilled in the art and as taught by the prior art. For example, the game computer terminal may be configured or programmed such that payment is not transacted via the computer system at all. Rather, the retail or convenience store clerk may be responsible to collect payment for the purchase of the game entries. In another embodiment, the terminal may include a simple confirmatory input, such as by keypad, that would communicate confirmation of payment such that the lottery computer system 210 would continue processing the transaction.

Upon purchase of the lottery ticket, the lottery computer 210 allocates a first portion of the ticket price of a purchased tax supplement lottery ticket to a tax supplement pool, at least a portion of which represents a tax supplement for lottery participant winners for at least a portion of applicable taxes on respective lottery prizes. Again, this allocation to a tax supplement pool may also occur at a separate tax supplement computer system 250 via the telecommunications network. The lottery computer 210 then allocates a second portion of the ticket price to a lottery prize pool, at least a portion of which represents respective lottery prizes for any lottery participant winners. Next, the lottery event occurs. This may be a separate, independent function. For example, many state sponsored lotteries are conducted live using a random drawing of painted ping pong balls. If the lottery drawing or selection of winning numbers, letters or other characters is a separate mechanical function, then the winning selection must be inputted into the computer system 210.

If there are any winners, computer system 210 accesses database 212 to identify how many winners. Often times the prizes are also calculated based upon the number of winners and the size of the prize pool. Once a lottery game participant presents his or her winning ticket, the system confirms the authenticity of the ticket (for example, by manual input or by optical scanning of the ticket) and provides notification of the proper award. The system 200 is typically designed to confirm prizes. The smaller prizes are usually redeemed at the retail or convenient store and the larger prizes redeemed at a centralized location. The lottery participant winners who purchased the tax supplement lottery ticket are awarded their prizes based upon the lottery prize pool and provided a tax supplement payment to cover at least a portion of the taxes owing for the prize.

The method of conducting the lottery with the tax supplement component may also include offering the game participant the opportunity to purchase a lottery ticket with no tax supplement component as is known in the prior art. Of course, lottery game participants who did not purchase the lottery ticket with the tax supplement component would not be provided a tax supplement payment and would be responsible for paying all applicable taxes (or the lottery sponsor or operator may remove applicable taxes from the prize money prior to giving such a winner his or her prize).

Additionally, the system 200 may also provide the lottery participant an opportunity to purchase lottery tax supplement option prior the lottery drawing. This would entitle a winning lottery participant who purchased a no-tax supplement lottery ticket to a tax supplement payment to offset at least a portion of taxes owed on awarded prizes.

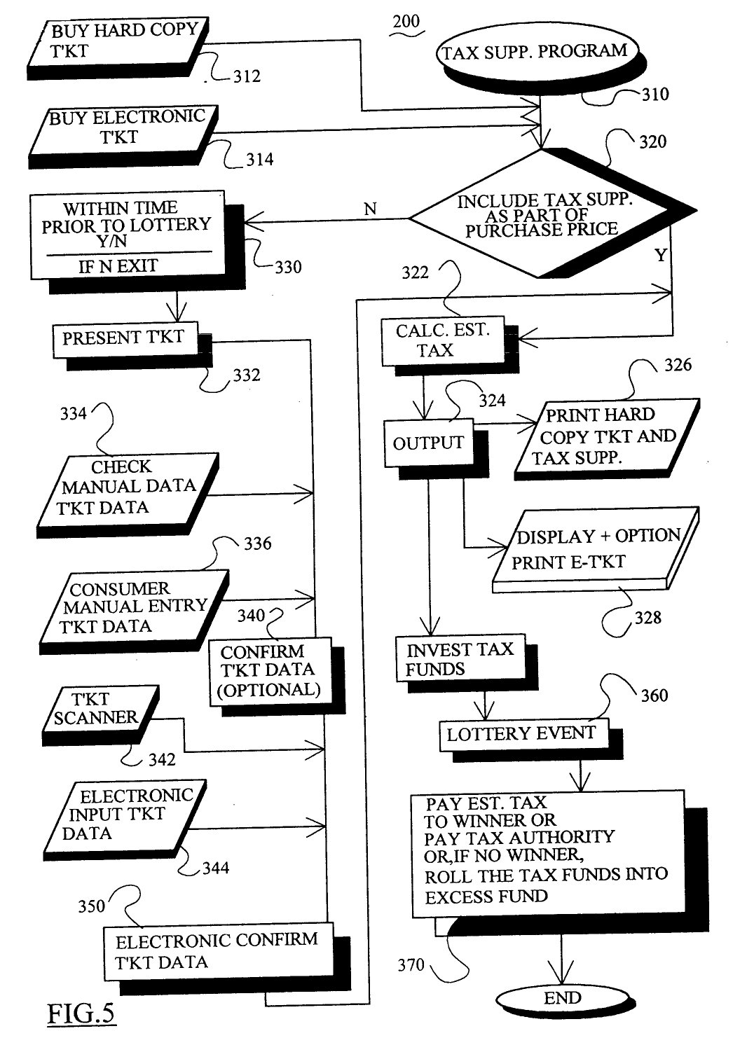

FIG. 5 provides an exemplary functional block diagram of various software components of a tax supplement program 310 for a lottery computer system 200. The gaming tax supplement program begins at 310. The tax supplement program or routine 310 is only necessary or needed when a game participant desires to purchase an entry or ticket to participate in a game event. Hence, inputs 312, 314 represent inputs to the program indicating a need for the tax supplement program. For example, a game participant may present a hard copy tkt 312 to a store clerk or request, via the Internet, to purchase an electronic tkt at 314. The request at 312, 314 could be generated viz-a-viz a manual input by a retail or convenience store clerk or by manual input by the game participant. It could also be generated viz-a-viz an optical scanner as previously discussed above. The entry ticket 314 may also be an electronic ticket. For example, the electronic ticket may be displayed to the game participant via a screen or other electronic display. The entry ticket may also be inputted via the Internet at a lottery computer terminal or a home computer system linked via a telecommunications network. Inputs 312, 314 simply represent an input to the tax supplement program 310 that a request has been made.

Once the program receives the inputted data regarding the game entry tickets, the program proceeds to query whether the game entry ticket includes the tax supplement as part of the purchase price at decision block 320. If yes, then the program calculates the estimated tax at block 322 and outputs data at block 324 for either printing a hard copy ticket inclusive of the tax supplement component at 326 or displaying an e-ticket with an option to print a hard copy 328. The calculation of the estimated tax may vary depending upon the type of game, the size of the wager, and how much of the applicable taxes for prizes will be paid. For example, in a lottery, the sponsor of the lottery may make the tax supplement price a fixed amount. As discussed above, this may be $0.25 for a $1.00 lottery ticket. By way of another example, if the gaming event is wagering on a sporting event, the price of the supplemental tax component or option may be based upon the amount of the wager. Accordingly, those who stand to gain the most also proportionately contribute to the tax supplement pool. It is important to note that the tax supplement financial product may be operated by a separate entity, other than the entity operating the game or lottery.

The tax supplement program 310 may also be used to provide game participants an opportunity to purchase a tax supplement option after placing the wager but prior to the gaming event. If the game participant had decided not to purchase a game entry with the tax supplement (decision block 320) at the time of initial purchase, then the program checks whether the game event has taken place at block 330. This time limitation is not fixed. For example, it may be prudent to stop selling or offering to sell game entries a few hours or minutes before the gaming event takes place. If the designated time or the game event has passed, then the program ends. The game participant is not permitted to purchase a tax supplement option for that particular game. If a predetermined time remains before the gaming event, then the program permits the presentation of the entry ticket (block 332) for verification such that the participant may purchase the tax supplement option. The presentation of the entry ticket at 332 may be conducted in a number of ways. For example, a retail store clerk may manually enter the ticket data 334, or the consumer/game participant may manually enter the ticket data 336. The tax supplement program may then confirm the ticket data at block 340. This step is optional.

Alternatively, as previously discussed, the ticket entry may be input via a scanner such as an optical scanner 342 or may be electronically input via a computer 344. The program can compare the entry ticket data against a database to verify its authenticity. If the ticket entry is valid, then the program proceeds to block 322 in order to calculate the appropriate price for the tax supplement option. At this point, the game participant would pay the appropriate option price and receive confirmation of participation in the game inclusive of the tax supplement option (see outputs 326, 328).

At least a portion of the funds collected for the tax supplement component would be invested as previously discussed. Next, a game event would occur. In FIG. 5, the game event is described as a lottery event at 360. After identifying any game winners who purchased the tax supplement component, the program would identify and generate a tax supplement schedule for paying the estimated applicable taxes owed by such winners. If there were no winners in general, or no winners who purchased a tax supplement ticket, then the funds in the supplemental tax pool are rolled over (see 370).

### Discussion of Hardware and Software Implementation Options

The present invention could be produced in hardware or software, or in a combination of hardware and software, and these implementations would be known to one of ordinary skill in the art. The system, or method, according to the inventive principles as disclosed in connection with the preferred embodiments, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as a local area network (LAN) or widely distributed network (WAN) over a telecommunications system (such as the Internet) as would be known to a person of ordinary skill in the art.

According to the inventive principles as disclosed in connection with the preferred embodiments, the invention and the inventive principles are not limited to any particular kind of computer system but may be used with any general purpose computer, as would be known to a person of ordinary skill in the art, arranged to perform the functions described and the method steps described herein. The operations of such a computer, as described above, may be according to a computer program contained on a medium for use in the operation or control of the computer, as would be known to person of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM or other optical memory storage devices, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

The claims appended hereto are meant to cover modifications and changes within the scope and spirit of the present invention.

What is claimed is:

1. A method for conducting a lottery game with a tax supplement component, the method comprising:
offering and permitting the purchase of a lottery ticket with a tax supplement component by lottery game participants, said lottery ticket having a ticket price;
allocating a first portion of said ticket price of a purchased tax supplement lottery ticket to a tax supplement pool, at least a portion of which represents a tax supplement for lottery participant winners for at least a portion of applicable taxes on respective lottery prizes;
allocating a second portion of said ticket price to a lottery prize pool, at least a portion of which represents respective lottery prizes for said lottery participant winners;
identifying and awarding said lottery participant winners from said lottery prize pool and providing a tax supplement payment for said lottery participant winners who purchased said tax supplement lottery ticket.

2. The method according to claim 1 wherein said tax supplement lottery ticket is a first lottery ticket and the method of conducting a lottery game further includes offering and permitting the purchase of a second lottery ticket with no tax supplement component.

3. The method according to claim 2 wherein said second lottery ticket has a second ticket price lower than said ticket price of said first lottery ticket.

4. The method according to claim 3 wherein respective portions of said first and second ticket prices are allocated to said lottery prize pool.

5. The method according to claim 1 wherein said providing a tax supplement payment for said lottery participant winners who purchased said tax supplement lottery ticket includes calculating said tax supplement payment based upon said tax supplement pool and said respective lottery prizes.

6. The method according to claim 1 further comprising:
offering and permitting the purchase of a lottery tax supplement option to said lottery game participants, said lottery tax supplement option having an associated price;
allocating at least a portion of said associated price of a purchased tax supplement option to said tax supplement pool;
identifying and making a provision for a tax supplement payment for said lottery participant winners who purchased said lottery tax supplement option for at least a portion of applicable taxes on respective lottery prizes awarded to said lottery participant winners.

7. A method for conducting a lottery game with a tax supplement component, the method comprising:
offering and permitting the purchase of a lottery tax supplement option to lottery game participants, said lottery tax supplement option having an associated price;
allocating at least a portion of said associated price of a purchased tax supplement option to a tax supplement pool, at least a portion of which represents a tax supplement for lottery participant winners;
identifying and making a provision for a tax supplement payment for said lottery participant winners who purchased said lottery tax supplement option for at least a portion of applicable taxes on respective lottery prizes awarded to said lottery participant winners.

8. The method according to claim 7 wherein said offering and permitting the purchase of a lottery tax supplement option to lottery game participants includes offering and permitting the purchase of a lottery ticket including said lottery tax supplement option at a ticket price including said associated price of said lottery tax supplement option.

9. The method according to claim 8 further comprising allocating a portion of said ticket price of purchased lottery tickets to a lottery prize pool, at least a portion of which represents respective lottery prizes for said lottery participant winners.

10. The method according to claim 7 wherein said identifying and making a provision for a tax supplement payment for said lottery participant winners who purchased said lottery tax supplement option includes calculating said tax supplement payment based upon said tax supplement pool and said respective lottery prizes.

11. The method according to claim 7 further comprising:
offering and permitting the purchase of a lottery ticket with no tax supplement component at a no-supplement ticket price;
allocating at least a portion of said no-supplement ticket price of a purchased no tax supplement lottery ticket to a lottery prize pool, at least a portion of which represents respective lottery prizes for said lottery participant winners; and
permitting lottery game participants to purchase said lottery tax supplement option at a different time from purchasing said no tax supplement lottery ticket.

12. A computerized method for conducting a lottery game with a tax supplement component, the computerized method comprising:
offering and permitting the purchase of a lottery ticket with a tax supplement component by lottery game participants, said lottery ticket having a ticket price;
electronically allocating a first representative portion of said ticket price of a purchased tax supplement lottery ticket to a tax supplement pool, at least a portion of which represents a tax supplement for lottery participant winners for at least a portion of applicable taxes on respective lottery prizes;
electronically allocating a second representative portion of said ticket price of said purchased tax supplement lottery ticket to a lottery prize pool, at least a portion of which represents respective lottery prizes for all lottery participant winners;
electronically identifying and generating awards for said lottery participant winners from said lottery prize pool and providing a provision for a tax supplement payment for said lottery participant winners who purchased said tax supplement lottery ticket.

13. The computerized method according to claim 12 wherein said tax supplement lottery ticket is a first lottery ticket and the method of conducting a lottery game further includes offering and permitting the purchase of a second lottery ticket with no tax supplement component.

14. The computerized method according to claim 13 wherein said second lottery ticket has a second ticket price lower than said ticket price of said first lottery ticket.

15. The computerized method according to claim 14 wherein respective portions of said first and second ticket prices are allocated to said lottery prize pool.

16. The computerized method according to claim 12 wherein said providing a provision for said tax supplement payment for said lottery participant winners who purchased said tax supplement lottery ticket includes calculating said tax supplement payment based upon said tax supplement pool and said respective lottery prizes.

17. The method according to claim 12 further comprising:
offering and permitting the purchase of a lottery tax supplement option to said lottery game participants, said lottery tax supplement option having an associated price;
electronically allocating at least a portion of said associated price of a purchased tax supplement option to said tax supplement pool; and
electronically identifying and making a provision for a tax supplement payment for said lottery participant winners who purchased said lottery tax supplement option for at least a portion of applicable taxes on respective lottery prizes awarded to said lottery participant winners.

18. The method according to claim 13 further comprising:
offering and permitting the purchase of a lottery tax supplement option to said lottery game participants, said lottery tax supplement option having an associated price;
electronically allocating at least a portion of said associated price of a purchased tax supplement option to said tax supplement pool; and
electronically identifying and making a provision for a tax supplement payment for said lottery participant winners who purchased said lottery tax supplement option for at least a portion of applicable taxes on respective lottery prizes awarded to said lottery participant winners.

19. A computerized method of conducting a lottery game with a tax supplement component via a primary lottery computer system coupled to at least one lottery computer terminal, the computerized method comprising:
offering and permitting the purchase of a lottery ticket with and without a tax supplement component via said at least one lottery computer terminal, said lottery ticket having first and second ticket prices, respectively;
at said primary lottery computer system:
allocating a first representative portion of said first ticket price of a purchased tax supplement lottery ticket to a tax supplement pool, at least a portion of which represents a tax supplement for lottery participant winners who purchased said tax supplement lottery ticket;
allocating a second representative portion of said first and second ticket prices to a lottery prize pool, at least a portion of which represents respective lottery prizes for all lottery participant winners;
identifying lottery winning tickets and prizes, if any; and
generating a tax supplement schedule based upon said tax supplement pool and said prizes.

20. The computerized method according to claim 19 further comprising conducting said computerized method via a web-based system wherein said primary lottery computer system includes at least one server computer, the method including coupling said server computer to said at least one lottery computer terminal via a telecommunications network.

21. The computerized method according to claim 19 wherein said generating said tax supplement schedule includes calculating tax supplement payments based upon said tax supplement pool and said prizes.

22. A computer readable medium containing programming instructions for conducting a lottery game with a tax supplement component from a primary lottery computer system coupled to at least one lottery computer terminal, the programming instructions comprising:
offering and permitting the purchase of a lottery ticket with a tax supplement component via said at least one lottery computer terminal, said lottery ticket having a ticket price;
at said primary lottery computer system:
associating a first representative portion of said ticket price of a purchased tax supplement lottery ticket to a tax supplement pool, at least a portion of which represents a tax supplement for lottery participant winners who purchased said tax supplement lottery ticket;
associating a second representative portion of said ticket price to a lottery prize pool, at least a portion of which represents respective lottery prizes for all lottery participant winners;
identifying lottery winning tickets and prizes, if any; and
generating a tax supplement schedule based upon said tax supplement pool and said prizes.

23. An information processing system for conducting a lottery game with a tax supplement component, said information processing system including at least one primary lottery computer system coupled to at least one lottery computer terminal, the system comprising:
at least one lottery computer terminal permitting the purchase of a lottery ticket with a tax supplement component, said lottery ticket having a ticket price;
means for allocating a first representative portion of said ticket price of a purchased tax supplement lottery ticket to a tax supplement pool, at least a portion of which represents a tax supplement for lottery participant winners who purchased said tax supplement lottery ticket;
means for allocating a second representative portion of said ticket price to a lottery prize pool, at least a portion of which represents respective lottery prizes for all lottery participant winners; and
a computer system for identifying lottery winning tickets and prizes, and for generating a tax supplement schedule based upon said tax supplement pool and said prizes.

24. A method of communicating information for conducting a lottery game with a tax supplement component between a primary lottery computer system and at least one lottery computer terminal of a plurality of lottery computer terminals, said lottery game including:
offering and permitting the purchase of a lottery ticket with and without a tax supplement component via said at least one lottery computer terminal, said lottery ticket having first and second ticket prices, respectively; and
at said primary lottery computer system, allocating a first representative portion of said first ticket price of a purchased tax supplement lottery ticket to a tax supplement pool, at least a portion of which represents a tax supplement for lottery participant winners who purchased said tax supplement lottery ticket;
allocating a second representative portion of said first and second ticket prices to a lottery prize pool, at least a portion of which represents respective lottery prizes for all lottery participant winners;
identifying lottery winning tickets and prizes, if any; and
generating a tax supplement schedule based upon said tax supplement pool and said prizes,
the method of communicating the information comprising:
transmitting a data packet representing said purchase of said lottery ticket with said tax supplement component from said at least one lottery computer terminal to said primary lottery computer system; and
gathering all said representative data packets from said plurality of lottery computer terminals prior to said identifying lottery winning tickets and prizes.

25. A method of conducting a lottery game with a tax supplement component, the method deployed in a server-client computer system with at least one server computer operatively coupled to at least one client computer over a communications network, said client computer accepting data input which includes lottery ticket data, and said at least one server computer allocating a representative portion of the lottery ticket price for any purchased lottery tickets to a lottery prize pool, at least a portion of which represents lottery prizes for lottery participant winners, and identifying any lottery winning tickets; the method comprising:
serving a lottery ticket offer for a ticket price which includes a tax supplement component via said at least one server computer to said at least one client computer;
confirming payment of said ticket price;
accepting lottery ticket selections as adapted to be uploaded from said at least one client computer;
allocating a first portion of said ticket price to a tax pool, at least a portion of which represents a tax supplement for said lottery participant winners for at least a portion of applicable taxes on respective lottery prizes; and
generating a tax supplement schedule based upon said tax supplement pool and said prizes.

26. A method of conducting a lottery game with a tax supplement component, the method deployed in a server-client computer system with at least one server computer operatively coupled to at least one client computer over a communications network, said client computer accepting data input which includes lottery ticket data, the method comprising:
serving a lottery ticket offer with a tax supplement component, said lottery ticket offer including a purchase price, said serving accomplished via a lottery server computer to at least one client computer;
accepting at said lottery server computer lottery selections based upon said lottery ticket offer upon confirmation of payment of said purchase price and as adapted to be uploaded from said at least one client computer;
allocating a first portion of said purchase price to a tax pool at said lottery server computer, at least a portion of which will be used to reimburse any winners of the next lottery for at least a portion of applicable federal, state, and local taxes on any respective lottery prizes;
allocating a second portion of said purchase price to a lottery award pool at said lottery server computer, at least a portion of which represents said respective lottery prizes from which any said winners are paid;
identifying lottery winners who purchased said lottery ticket including a tax supplement component such that any said winners may be reimbursed for at least a portion of said taxes from said tax pool.

27. A method for conducting a game of chance with a tax supplement component, the method comprising:
offering and permitting the purchase of a wager with a tax supplement component by game participants, said wager having a price;
allocating a first portion of said price of a purchased tax supplement wager to a tax supplement pool, at least a portion of which represents a tax supplement for game participant winners for at least a portion of applicable taxes on respective game prizes;
allocating a second portion of said price to a game prize pool, at least a portion of which represents respective game prizes for said game participant winners;
identifying and awarding said game participant winners from said game prize pool and providing a tax supplement payment for said game participant winners who purchased said tax supplement wager.

28. The method according to claim 27 wherein said tax supplement wager is a first wager and the method of conducting a game of chance further includes offering and permitting the purchase of a second wager with no tax supplement component.

29. The method according to claim 28 wherein said second wager has a second price lower than said price of said first wager.

30. The method according to claim 29 wherein respective portions of said first and second wager prices are allocated to said game prize pool.

31. The method according to claim 27 wherein said providing a tax supplement payment for said game participant winners who purchased said tax supplement wager includes calculating said tax supplement payment based upon said tax supplement pool and said respective game prizes.

32. The method according to claim 27 further comprising:
offering and permitting the purchase of a wager tax supplement option to said game participants, said wager tax supplement option having an associated price;
allocating at least a portion of said associated price of a purchased tax supplement option to said tax supplement pool;
identifying and making a provision for a tax supplement payment for said game participant winners who purchased said wager tax supplement option for at least a portion of applicable taxes on respective game prizes awarded to said game participant winners.

33. A method for conducting an electronic game of chance with a tax supplement component, the method comprising:
offering and permitting the purchase of a tax supplement wager option to game participants, said tax supplement wager option having an associated price;
allocating at least a portion of said associated price of a purchased tax supplement wager option to a tax supplement pool, at least a portion of which represents a tax supplement for game participant winners;
identifying and making a provision for a tax supplement payment for said game participant winners who purchased said tax supplement wager option for at least a portion of applicable taxes on respective game prizes awarded to said game participant winners.

34. The method according to claim 33 wherein said offering and permitting the purchase of said tax supplemented wager option to game participants includes offering and permitting the purchase of a wager including said tax supplement wager option at an aggregate price including said associated price of said tax supplement wager option.

35. The method according to claim 34 further comprising allocating a portion of said aggregate price of purchased wagers to a game prize pool, at least a portion of which represents respective game prizes for said game participant winners.

36. The method according to claim 33 wherein said identifying and making a provision for a tax supplement payment for said game participant winners who purchased said tax supplement wage option includes calculating said tax supplement payment based upon said tax supplement pool and said respective game prizes.

37. The method according to claim 33 further comprising:
offering and permitting the purchase of a wager with no tax supplement component at a no-supplement price;
allocating at least a portion of said no-supplement price of a purchased no tax supplement wager to a game prize pool, at least a portion of which represents respective game prizes for said game participant winners; and
permitting game participants to purchase said tax supplement wager option at a different time from purchasing said no tax supplement wager.
